(19) United States
(12) Patent Application Publication
(10) Pub. No.: US 2012/0161673 A1
(43) Pub. Date: Jun. 28, 2012

(54) PARTICLE ACCELERATOR HAVING A SWITCH ARRANGEMENT NEAR AN ACCELERATOR CELL

(76) Inventors: Oliver Heid, Erlangen (DE); Timothy Hughes, Erlangen (DE)

(21) Appl. No.: 13/393,366

(22) PCT Filed: Jul. 23, 2010
(86) PCT No.: PCT/EP2010/060682

§ 371 Date: Mar. 2, 2012

(30) Foreign Application Priority Data
Sep. 3, 2009 (DE) 102009039998.4

(51) Int. Cl. H05H 7/00

(52) U.S. Cl. 315/506

(57) ABSTRACT

A particle accelerator may include at least one accelerator cell and a power supply device. The power supply device may provide electrical energy to the accelerator cell via a feed line. With electrical energy received via the feed line, the accelerator cell may generate an electric field for accelerating an electrically charged elementary particle. The power supply device may have a DC current source and a switch arrangement. The power supply device may be designed such that electrical energy provided by the DC circuit source is capacitively buffered, and upon corresponding actuation of the switch arrangement, is provided to the acceleration cell. The switch arrangement may be disposed near the acceleration cell such that the switch arrangement is exposed to ionizing radiation generated by the particle accelerator at least during operation. The DC circuit source may be connected to the switch arrangement via a first cable.

### CROSS-REFERENCE TO RELATED APPLICATIONS

This application is a U.S. National Stage Application of International Application No. PCT/EP2010/060682 filed Jul. 23, 2010, which designates the United States of America, and claims priority to DE Patent Application No. 10 2009 039 998.4 filed Sep. 3, 2009. The contents of which are hereby incorporated by reference in their entirety.

### TECHNICAL FIELD

The present disclosure relates to a particle accelerator.

### BACKGROUND

In certain known particle accelerators, the DC current source is typically configured as a rectifier, which is fed from the power supply system. The power the rectifier draws from the power supply system is relatively low. By way of example, it can lie in the single-digit kilowatt range. The switch arrangement is not actuated most of the time. The switch arrangement is actuated only during short pulse times such that the accelerator cell is fed electric energy. During these short—often extremely short—pulse times, a power of significant magnitude, often in the single-digit or even double-digit megawatt range, flows in the feed line.

In order to not only make possible a very high energy flow during the pulse times but to also need a significantly lower energy inflow from the power supply system during the times between the pulse times—referred to as “rest times” below—, the power supply device needs to have a sufficiently large energy storage means, which is arranged in a circuit between the DC voltage source and the switch arrangement. In conventional accelerators, this energy storage means may be configured as a storage capacitor device. Storage capacitors of the storage capacitor device are typically configured as electrolytic capacitors.

The accelerator cell generates ionizing radiation (X-rays, gamma rays, neutrons) at least during operation. The storage capacitor device reacts sensitively to such radiation. For this reason it needs to be protected against radiation of this type. In conventional arrangements, the protection is realized by arranging the accelerator cell in an accelerator space which is radiation-shielded such that the ionizing radiation generated by the accelerator cell remains constrained to the accelerator space. In conventional arrangements, the power supply device is arranged in a switch cabinet that is arranged outside the accelerator space. Owing to this configuration, the feed line often has a significant length, in many cases of several meters. By comparison, the distance between the DC current source and the switch arrangement is relatively small.

Arranging the power supply device at a distance from the accelerator cell may have various disadvantages. The largest disadvantage is that, owing to the intrinsic inductance of the feed line in conjunction with the maximum possible energy contents of the pulses, the maximum possible current and thus the maximum possible power may be limited. In some conventional systems, however, the power supply device is arranged at a distance from the accelerator cell to avoid a risk that the ionizing radiation generated by the accelerator cell triggers reactions in the power supply device which could lead to damage or even destruction of the power supply device.

### SUMMARY

In one embodiment, a particle accelerator is provided in which: the particle accelerator has at least one accelerator cell; the particle accelerator has a power supply device; the power supply device is connected to the accelerator cell via a feed line, so that electric energy can be fed in pulsed form to the accelerator cell via the feed line; the accelerator cell generates an electric field owing to the electric energy fed thereto, by means of which electric field an electrically charged elementary particle is accelerated; the power supply device has a DC current source and a switch arrangement; the power supply device is configured such that electric energy provided by the DC current source is capacitively buffered, and upon corresponding control of the switch arrangement, is fed to the accelerator cell; and the switch arrangement is arranged near the accelerator cell, with the result that it is exposed to ionizing radiation generated by the particle accelerator at least during operation and in that the DC current source is connected to the switch arrangement via a first cable.

In a further embodiment, the DC current source is arranged at a distance from the accelerator cell such that it is not exposed to the ionizing radiation generated by the particle accelerator at least during operation. In a further embodiment, the accelerator cell is arranged in an accelerator space, in that the switch arrangement is likewise arranged in the accelerator space and in that the DC current source is arranged outside of the accelerator space. In a further embodiment, the DC current source is arranged in a switch cabinet and in that the switch arrangement is arranged outside of this switch cabinet. In a further embodiment, a distance of the DC current source from the switch arrangement is greater than a distance of the switch arrangement from the accelerator cell. In a further embodiment, the capacitive buffering is effected at least partially by the first cable. In a further embodiment, a storage capacitor device is arranged between the DC current source and the first cable. In a further embodiment, the storage capacitor device is enclosed by a first shielding means, which is used to shield the storage capacitor device against the ionizing radiation generated by the particle accelerator at least during operation. In a further embodiment, a compensation capacitor device is arranged between the switch arrangement and the first cable. In a further embodiment, the compensation capacitor device has a capacitance value which is only a fraction of the overall capacitance of the power supply device effecting capacitive buffering.

In a further embodiment, power supply device has a control unit for controlling the switch arrangement, in that the control unit is arranged at a distance from the accelerator cell and in that the control unit is connected to at least one control input of the switch arrangement via a second cable. In a further embodiment, the control unit is arranged near the DC current source. In a further embodiment, the control unit is enclosed by a second shielding means, with which the control unit is shielded against the ionizing radiation generated by the particle accelerator at least during operation.

### BRIEF DESCRIPTION OF THE DRAWINGS

Example embodiments will be explained in more detail below with reference to figures, in which:

FIG. 1 shows the principle of a particle accelerator, according to certain embodiments,

FIG. 2 shows an example configuration of a switch arrangement, according to an embodiment, and

FIG. 3 shows a circuit diagram of an example power supply device of the particle accelerator in FIG. 1 and additionally a control unit, according to certain embodiments.

### DETAILED DESCRIPTION

In some embodiments, a particle accelerator is provided that provides higher pulse powers as compared with certain conventional accelerators, without having to tolerate the risk of damage to the power supply device.

Some embodiments provide a particle accelerator having a switch arrangement arranged near the accelerator cell, such that it is exposed to ionizing radiation generated by the particle accelerator at least during operation and such that the DC current source is connected to the switch arrangement via a first cable.

The first cable may be a shielded cable, e.g., a coaxial cable.

In some embodiments, the DC current source is arranged at a distance from the accelerator cell, such that it is not exposed to the ionizing radiation generated by the particle accelerator at least during operation. By way of example, the accelerator cell can be arranged in an accelerator space, the switch arrangement can likewise be arranged in the accelerator space and the DC current source can be arranged outside of the accelerator space. Alternatively or additionally it is possible for the DC current source to be arranged in a switch cabinet and for the switch arrangement to be arranged outside of this switch cabinet. In some embodiments, a distance of the DC current source from the switch arrangement is greater than a distance of the switch arrangement from the accelerator cell.

The electric energy supplied by the DC current source may be capacitively buffered. However, n contrast with certain conventional accelerators, however, the capacitive buffering may be effected at least partially by the first cable. The proportion of the first cable with respect to a total capacitance of the power supply device effecting capacitive buffering can be considerable. In particular, the proportion of the first cable can be more than 30 percent. Still greater proportions, such as 50 percent or 70 percent, are also possible. In some cases even a proportion of almost 100 percent is achievable.

If the capacitance provided by the first cable by itself is not sufficient, a storage capacitor device can be arranged between the DC current source and the first cable. The storage capacitor device can be configured similar to a conventional device, but smaller. If the storage capacitor device is present, it is preferably enclosed by a first shielding means, which may be used to shield the storage capacitor device against the ionizing radiation generated by the particle accelerator at least during operation.

A compensation capacitor device may also be arranged between the switch arrangement and the first cable. The compensation capacitor device, however, is used not so much for buffering electric energy but rather for smoothing. For this reason, the compensation capacitor device, if present, may have a capacitance value which is only a fraction of the overall capacitance of the power supply device effecting capacitive buffering. The compensation capacitor device furthermore typically has no electrolytic capacitors.

In some embodiments, the switch arrangement is controlled using a corresponding control unit. The power supply device therefore has a control unit for controlling the switch arrangement. The control unit frequently also reacts sensitively to ionizing radiation. Therefore, the control unit is preferably arranged at a distance from the accelerator cell and connected to at least one control input of the switch arrangement via a second cable. By way of example, the control unit can be arranged near the DC current source.

The control unit is preferably enclosed by a second shielding means, with which the control unit may be shielded against the ionizing radiation generated by the particle accelerator at least during operation. The second shielding means and the first shielding means may be identical.

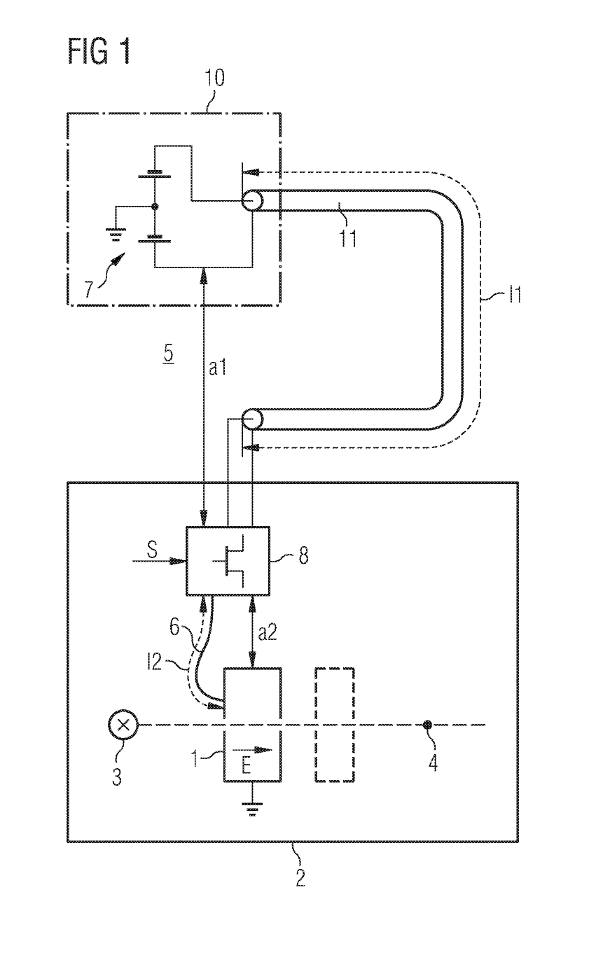

According to FIG. 1, an example particle accelerator has an example accelerator cell 1, according to certain embodiments. The accelerator cell 1 is arranged in an accelerator space 2.

If desired, further accelerator cells may be additionally arranged in the accelerator space 2, one of which is indicated in FIG. 1 with a dashed line. The accelerator space 2 is evacuated during operation of the particle accelerator, i.e. the accelerator space 2 contains a vacuum. A particle source 3 is further arranged in the accelerator space 2. The particle source 3 emits, during operation of the particle accelerator, charged elementary particles 4, for example protons, electrons or alpha particles.

The particle accelerator furthermore has a power supply device 5. The power supply device 5 is connected to the accelerator cell 1 via a feed line 6. Via the feed line 6, electric energy is suppliable to the accelerator cell 1 in pulsed form.

Owing to the electric energy supplied to the accelerator cell 1, the latter generates an electric field E. The elementary particles 4 emitted by the particle source 3 are accelerated using the electric field E.

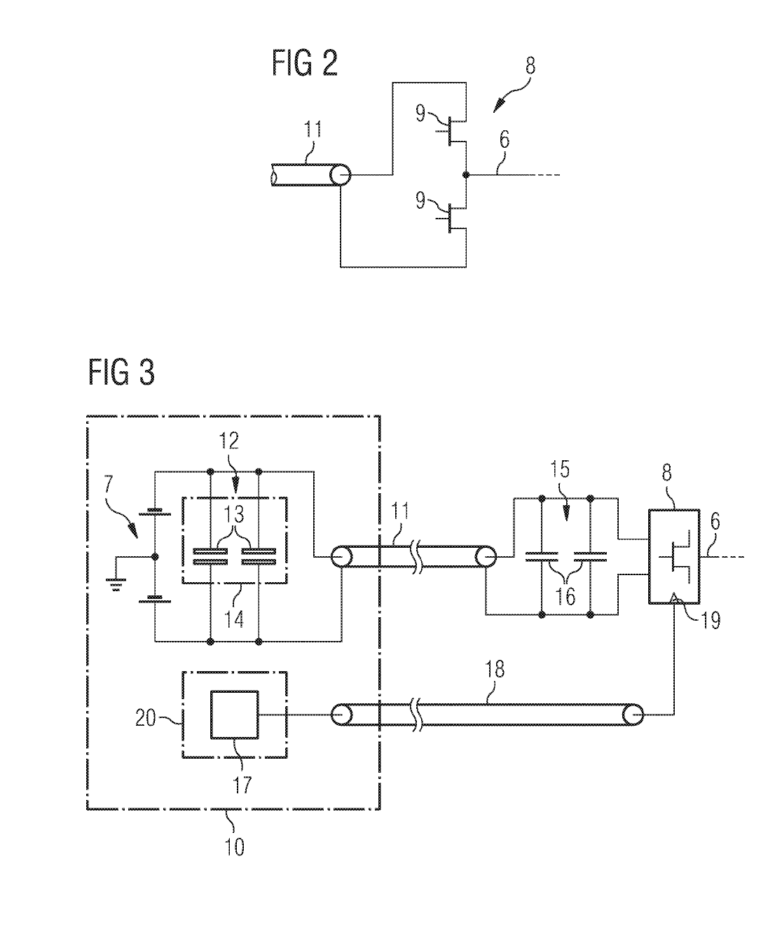

According to the example embodiment of FIG. 1, the power supply device 5 has a DC current source 7 and a switch arrangement 8. The DC current source 7 can be configured, for example as a rectifier, which is supplied from the general electric supply system. The electric switch arrangement 8 can be configured as needed. By way of example, according to FIG. 2, it can have two electric semiconductor power switches 9, such that one positive or one negative pulse can be emitted to the accelerator cell 1 using the switch arrangement 8. The semiconductor power switches 9 can in particular be configured as field-effect transistors.

The power supply device 5 may be configured such that electric energy supplied by the DC current source 7 is capacitively buffered. During idle times, that is to say while no electric energy is supplied to the accelerator cell 1, a total capacitance is charged by the DC current source 7. With appropriate control of the switch arrangement 8—for example on the basis of a corresponding control signal S—, the buffered electric energy is supplied to the accelerator cell 1.

According to FIG. 1, the DC current source 7 is arranged outside of the accelerator space 2. By way of example, the DC current source 7 can be arranged in a switch cabinet 10, which for its part is arranged outside of the accelerator space 2. By arranging the DC current source 7 outside of the accelerator space 2, it is in particular possible to achieve a situation in which the DC current source 7 is arranged at a distance from the accelerator cell 1, and is therefore not exposed to ionizing radiation emitted by the particle accelerator during operation.

The switch arrangement 8 may be arranged near the accelerator cell 1. The switch arrangement 8 is exposed to the ionizing radiation generated by the particle accelerator during operation. By way of example, the switch arrangement 8 can be arranged in the accelerator space 2. Alternatively, the switch arrangement 8 can be arranged outside of the accelerator space 2, for example on its external wall. If the DC current source 7 is arranged in the switch cabinet 10, the switch arrangement 8 is generally arranged outside of the switch cabinet 10.

Owing to the arrangement of the DC current source 7 and the switch arrangement 8, the DC current source 7 and the switch arrangement 8 may be arranged at a distance from each other. The DC current source 7 and the switch arrangement 8 are connected to each other via a first cable 11. The first cable 11 is typically a shielded cable. The cable may be configured as a coaxial cable according to the illustration of FIG. 1.

In some embodiments, a distance a1 of the DC current source 7 from the switch arrangement 8 (and thus a length 11 of the first cable 11) is greater than a distance a2 of the switch arrangement 8 and the accelerator cell 1 (and thus the length 12 of the feed line 6). By way of example, in absolute terms, the distance a1 can be more than five meters, in particular more than ten meters. The distance a2, by contrast, can be less than two meters. In relative terms, a ratio of distance a1 to the distance a2 may be at least 2:1, for example. Often the ratio of the distances a1, a2 can even be more than 5:1 or more than 10:1. Similar statements apply to the lengths 11, 12 and their ratios.

The first cable 11 acts—in particular in the case of the configuration as a coaxial cable—as a distributed capacitance. The capacitive buffering of the electric energy is therefore effected at least partially by the first cable 11. In the example configuration according to FIG. 1, where no further capacitor devices are present, the capacitive buffering is even effected exclusively by the first cable 11.

FIG. 3 shows one possible configuration of the power supply device 5 of the particle accelerator of FIG. 1, according to an example embodiment. The configuration of FIG. 3 differs from the configuration of FIG. 1 in that the capacitive buffering is effected only partially and not completely by the first cable 11. By way of example, in accordance with the configuration of FIG. 3, a storage capacitor device 12 can additionally be present. The storage capacitor device 12 is arranged according to FIG. 3 between the DC current source 7 and the first cable 11. It can be arranged for example in the switch cabinet 10, in which the DC current source 7 is also arranged.

The storage capacitor device 12 may be configured similar to a conventional device. In particular, it may have at least one electrolytic capacitor 13.

In accordance with the example shown in FIG. 3, the storage capacitor device 12 may be enclosed by a first shielding means 14. With the first shielding means 14, the storage capacitor device 12 is shielded against the ionizing radiation generated by the particle accelerator at least during operation. The first shielding means 14 can—depending on the type of the ionizing radiation that necessitates shielding means—include, e.g., lead, borated polyethylene, or other suitable materials or comprise these materials as constituent parts.

The proportion of the storage capacitor device 12 based on the overall capacitance of the power supply device 5, which effects capacitive buffering of the electric energy, can be determined as appropriate. It may be a few percent, for example five percent, eight percent or ten percent. It can also be more, for example 20 percent, 30 percent or 40 percent. Typically the proportion of the storage capacitor device 12 based on the overall capacitance is less than 50 percent.

Furthermore, a compensation capacitor device 15 is typically also present. The compensation capacitor device 15 has capacitors 16, which are not configured as electrolytic capacitors. According to FIG. 3, the compensation capacitor device 15 is arranged between the first cable 11 and the switch arrangement 8.

The proportion of the compensation capacitor device 15 based on the overall capacitance of the power supply device 5 can also be determined as appropriate. Typically, the compensation capacitor device 15 has a capacitance value which is only a small fraction of the overall capacitance of the power supply device 5. Typically, the fraction is at most two percent of the overall capacitance, for example only one percent of the overall capacitance. Smaller proportions are also possible.

As mentioned above, in some embodiments the control signal S is supplied to the switch arrangement 8. To this end, a control unit 17 is provided according to FIG. 3. The control unit 17 is preferably a component of the power supply device 5. The control unit 17 is arranged—similarly to the DC current source 7 and possibly also similarly to the storage capacitor device 12—at a distance from the accelerator cell 1. By way of example, the control unit 17 can be arranged, according to the illustration of FIG. 3, near the DC current source 7. In particular, it may optionally be arranged in the switch cabinet 10, which also houses the DC current source 7.

For transmitting the control signal S, the control unit 17 is connected to at least one control input 19 of the switch arrangement 8 via a second cable 18. The second cable 18 is—similarly to the first cable 11—preferably a shielded cable. For example, it can be configured as a coaxial cable.

Depending on the particular embodiment and/or situation, it may be necessary for the control unit 17 to be shielded against the ionizing radiation emitted by the particle accelerator during operation. If this is necessary, the control unit 17 is, to this end, enclosed by a second shielding means 20, according to FIG. 3. The second shielding means 20 can be configured similarly to the first shielding means 14.

The control unit 17 may be used both in the example configuration of the particle accelerator according to FIG. 1 and in the example configuration of the particle accelerator according to FIG. 3. If the first and the second shielding means 14, 20 are present, the two shielding means 14, 20 can possibly be combined as one common shielding means, which encloses both the storage capacitor device 12 and the control unit 17.

Embodiments of the present invention have various advantages. For example, it may be possible with little effort to achieve high pulse powers and shorter pulses than in the conventional systems.

### LIST OF NUMBERED ELEMENTS

1 accelerator cell
2 accelerator space
3 particle source
4 elementary particle
5 power supply device
6 feed line
7 DC current source
8 switch arrangement
9 semiconductor power switch
10 switch cabinet
11, 18 cable
12, 15 capacitor devices
13, 16 capacitors
14, 20 shielding means
17 control unit
a1, a2 distances
E electric field
11, 12 lengths
S control signal

What is claimed is:

1. A particle accelerator, comprising:
an accelerator cell,
a power supply device, connected to the accelerator cell via a feed line to provide electric energy in pulsed form to the accelerator cell via the feed line,
wherein the accelerator cell generates an electric field owing to the electric energy provided thereto, the electric field provided to accelerate an electrically charged elementary particle,
wherein the power supply device has a DC current source and a switch arrangement,
wherein the power supply device is configured such that electric energy provided by the DC current source is capacitively buffered, and upon corresponding control of the switch arrangement, is provided to the accelerator cell, and
wherein the switch arrangement is arranged near the accelerator cell such that it is exposed to ionizing radiation generated by the particle accelerator at least during operation of the particle accelerator, and
wherein the DC current source is connected to the switch arrangement via a first cable.

2. The particle accelerator of claim 1, wherein the DC current source is arranged at a distance from the accelerator cell such that it is not exposed to the ionizing radiation generated by the particle accelerator during operation of the particle accelerator.

3. The particle accelerator of claim 1,
wherein the accelerator cell is arranged in an accelerator space,
wherein the switch arrangement is likewise arranged in the accelerator space, and
wherein the DC current source is arranged outside of the accelerator space.

4. The particle accelerator of claim 1,
wherein the DC current source is arranged in a switch cabinet, and
wherein the switch arrangement is arranged outside of this switch cabinet.

5. The particle accelerator of claim 1, wherein a distance of the DC current source from the switch arrangement is greater than a distance of the switch arrangement from the accelerator cell.

6. The particle accelerator of claim 1, wherein the capacitive buffering is effected at least partially by the first cable.

7. The particle accelerator of claim 6, wherein a storage capacitor device is arranged between the DC current source and the first cable.

8. The particle accelerator of claim 7, wherein the storage capacitor device is enclosed by a first shielding means that shields the storage capacitor device against the ionizing radiation generated by the particle accelerator at least during operation of the particle accelerator.

9. The particle accelerator of claim 6, wherein a compensation capacitor device is arranged between the switch arrangement and the first cable.

10. The particle accelerator of claim 9, wherein the compensation capacitor device has a capacitance value which is only a fraction of the overall capacitance of the power supply device effecting capacitive buffering.

11. The particle accelerator of claim 1,
wherein the power supply device has a control unit for controlling the switch arrangement,
wherein the control unit is arranged at a distance from the accelerator cell, and
wherein the control unit is connected to at least one control input of the switch arrangement via a second cable.

12. The particle accelerator of claim 11, wherein the control unit is arranged near the DC current source.

13. The particle accelerator of claim 11, wherein the control unit is enclosed by a second shielding means that shields the control unit against the ionizing radiation generated by the particle accelerator at least during operation of the particle accelerator.

14. A particle accelerator, comprising:
an accelerator cell,
a power supply device configured to provide power to the accelerator cell for particle acceleration,
wherein the power supply device has a DC current source and a switch arrangement,
wherein the switch arrangement is arranged such that it is exposed to ionizing radiation generated by the particle accelerator during operation of the particle accelerator, and
wherein the DC current source is arranged such that it is not exposed to ionizing radiation generated by the particle accelerator during operation of the particle accelerator.

15. The particle accelerator of claim 14, wherein electric energy provided by the DC current source is capacitively buffered before being provided to the accelerator cell.

16. The particle accelerator of claim 15, wherein the DC current source is connected to the switch arrangement via a first cable, and wherein the capacitive buffering is effected at least partially by the first cable.

17. The particle accelerator of claim 14,
wherein the accelerator cell is arranged in an accelerator space,
wherein the switch arrangement is likewise arranged in the accelerator space, and
wherein the DC current source is arranged outside of the accelerator space.

18. The particle accelerator of claim 14,
wherein the DC current source is arranged in a switch cabinet, and
wherein the switch arrangement is arranged outside of this switch cabinet.

19. The particle accelerator of claim 14, wherein a distance of the DC current source from the switch arrangement is greater than a distance of the switch arrangement from the accelerator cell.

20. The particle accelerator of claim 6,
wherein a compensation capacitor device is arranged between the switch arrangement and the first cable, and
wherein the compensation capacitor device has a capacitance value which is only a fraction of the overall capacitance of the power supply device effecting capacitive buffering.
